(19) United States
(12) Patent Application Publication
(10) Pub. No.: US 2023/0201715 A1
(43) Pub. Date: Jun. 29, 2023

(54) INTERACTIVE VIDEO PLAYER

(71) Applicant: TCL Research America Inc., San Jose, CA (US)

(72) Inventor: Haohong WANG, San Jose, CA (US)

(21) Appl. No.: 17/739,605

(22) Filed: May 9, 2022

Related U.S. Application Data
(60) Provisional application No. 63/293,195, filed on Dec. 23, 2021.

(51) Int. Cl. A63F 13/52; G06T 13/40

(52) U.S. Cl. CPC A63F 13/52; G06T 13/40

(57) ABSTRACT

An interactable video playback method includes: obtaining an interactable video sequence including a plurality of interactable data regions and a plurality of non-interactable data regions, wherein each interactable data region stores video data and non-video data associated with interaction, and each non-interactable data region stores a two-dimensional (2D) video clip; playing the interactable video sequence; detecting a join request from a user; and in response to the join request occurring when playing one of the plurality of interactable data regions, allowing an avatar of the user to interact with an object in a scene corresponding to the interactable data region being played.

### CROSS-REFERENCE TO RELATED APPLICATION

This application claims the priority of U.S. Provisional Patent Application No. 63/293,195, filed on Dec. 23, 2021, the entire content of which is incorporated herein by reference.

### FIELD OF THE DISCLOSURE

The present disclosure relates to the field of video technologies and, more particularly, relates to an interactive video playback method and an interactive video player.

### BACKGROUND

With the rapid growth of augmented reality/virtual reality (AR/VR) and metaverse, new user demands and applications will impact the TV and mobile video industry. For example, a user may have his/her own avatar and want to see him/her explore a virtual world through the avatar. In another example, while watching a video, the user may interact with a character in a story of the video and change an ending of the story.

### BRIEF SUMMARY OF THE DISCLOSURE

One aspect of the present disclosure provides an interactable video playback method. The method includes: obtaining an interactable video sequence including a plurality of interactable data regions and a plurality of non-interactable data regions, where each interactable data region stores video data and non-video data associated with interaction, and each non-interactable data region stores a two-dimensional (2D) video clip; playing the interactable video sequence; detecting a join request from a user; and in response to the join request occurring when playing one of the plurality of interactable data regions, allowing an avatar of the user to interact with an object in a scene corresponding to the interactable data region being played.

Another aspect of the present disclosure includes an interactable video player. The interactable video player includes: a display screen for displaying a video sequence; a memory storing program instructions; and a processor coupled with the memory and configured to execute the program instructions to: obtain an interactable video sequence including a plurality of interactable data regions and a plurality of non-interactable data regions, wherein each interactable data region stores video data and non-video data associated with interaction, and each non-interactable data region stores a two-dimensional (2D) video clip; play the interactable video sequence; detect a join request from a user; and in response to the join request occurring when playing one of the plurality of interactable data regions, allow an avatar of the user to interact with an object in a scene corresponding to the interactable data region being played.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic structural diagram of an exemplary interactable video player according to some embodiments of the present disclosure;

FIG. 2 illustrates a flowchart of an exemplary interactable video playback method according to some embodiments of the present disclosure;

FIG. 3 illustrates a frame structure of a sample video sequence according to some embodiments of the present disclosure;

FIG. 4 illustrates a sample interactable segment according to some embodiments of the present disclosure;

FIG. 5 illustrates another sample interactable segment according to some embodiments of the present disclosure;

FIG. 6 illustrates another sample interactable segment according to some embodiments of the present disclosure;

FIG. 7 illustrates another sample interactable segment according to some embodiments of the present disclosure;

FIG. 8 illustrates another sample interactable segment according to some embodiments of the present disclosure;

FIG. 9 illustrates another sample interactable segment according to some embodiments of the present disclosure;

FIG. 10 illustrates a sample two-dimensional (2D) video frame or a same three-dimensional (3D) scene according to some embodiments of the present disclosure;

FIG. 11 illustrates user's avatar walking inside the 3D scene according to some embodiments of the present disclosure;

FIG. 12 and FIG. 13 illustrate sample objects being interactable according to some embodiments of the present disclosure; and

FIG. 14 illustrates user taking over the voice of a character according to some embodiments of the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

With the rapid growth of augmented reality (AR)/virtual reality (VR) and Metaverse, new user demands and applications will impact the TV and mobile video industry, as a user will have his/her own avatar and want to see himself/herself (using his/her avatar) to explore the virtual world. An interactable video playback experience makes a story in a 2D video format become an interactable media format that the user can engage and enter into the 3D story world to explore any time. The user can also interact with a story character with conversations and may even change the ending of the story.

In the specification, the term “interactive” and the term “interactable” are used interchangeably. Either term refers to a video playback method or a video player with which a user can interact and at the same time, an interactive/interactable video is compatible with any existing non-interactable video form-factor and can be played by a non-interactable video player. In addition, an interactable video sequence or an interactable video sequence file will be used interchangeably in the specification to refer to the interactable video in an interactable video form-factor. The interactable video sequence can be stored in a memory device or can be streamed from a video streaming server or another video player over a communication network. An interactive video, as disclosed herein, can be referred to as an IDEO. The interactive video can be processed and played by an IDEO player.

The interactable video form-factor described in the disclosure has the following beneficial effects.

A multi-ending story is not required. The interactable video sequence can be a single-pass single-ending story, which does not require the user to choose among multiple options periodically.

The user is allowed to enter (with the avatar) the story, which means pausing a playing 2D video, entering a 3D scene, and starting exploration and interacting with objects in the 3D scene (e.g., talking to a character, physically interacting with an object like kicking a ball, and so on) and the user is allowed to leave the 3D scene and return to the 2D video story anytime the user wants.

An interactable video sequence creator is allowed to customize the experience by simple interactions (e.g., replacing a character with the user himself/herself, changing a dialogue of a character with the user's own voice and own words) without entering the 3D scene or 3D virtual world.

The interactable video sequence creator is allowed to specify a game with gaming rules (e.g., gaming data), so that after the user enters a 3D scene, the user can achieve a goal pre-assigned following the gaming rules and interaction formulas. For example, the user can customize a character in the 3D scene to support the traditional family game of “Who is telling the truth” and let other users play together.

The interactable video sequence creator is allowed to customize immersive ambient experiences with various IoT devices when watching the video or exploring the 3D scene. In one example, all home lights are turned off when the user enters a dark forest in the 3D scene. In another example, an ocean scent can be released with cool breeze (from air conditioning or smart fan) when the user lands on a beach in the 3D scene.

In the embodiments of the present disclosure, the interactable video watching experience includes customization, gaming and multi-device collaboration. The user can enjoy the interactable video watching experience using all types of displays (e.g., TV, phone, tablet, projectors, AR/VR headsets, and so on) while being coordinated with smart home IoT devices (e.g., AC, fans, speaker, light, and so on).

In the scenarios that 2D and 3D video playbacks are switched back and forth, the 2D video data is integrated with 3D VR data such that the 2D video can be played inside the 3D VR environment. In an exemplary switching mechanism, two different media players (i.e., a 2D video player and an interactable video player) handle two types of video data from different sources, and outputs of the two players are combined into a single video sequence. The interactable video player can also be an artificial intelligence (AI) video player. Various video data types can be stored in different files and thus prepared for different video players, thus metafile information is required to support matching and synchronization of these files.

In the embodiments of the present disclosure, a single-file single-player solution is described. In this case, all 2D and 3D data are co-located in a same streaming sequence or data file and coupled together. Thus, there is no need to have any additional metafile for matching and synchronizing multiple data files, and a single player is able to handle the 2D video playback, 3D scene rendering, game running, and immersive effect generation. The interactable video sequence is generated during a content design and creation process, thus the interactable video sequence, graphical environment, gaming rules, interaction formula, and hardware control commands, or a combination thereof, are generated side by side and co-located in the interactable video sequence.

The present disclosure provides an interactable video player. The interactable video player plays a video that is stored locally or streamed in real time on a display screen. In response to an operation performed by a user of the interactable video player, the interactable video player allows or disables the user to interact with an object in a current scene of the video. The object can be a physical item or a character in the current scene. When the user interacts with the video, the interaction is displayed on the display screen, thereby enhancing user's experience of watching the video.

FIG. 1 illustrates a schematic structural diagram of an exemplary interactable video player to some embodiments of the present disclosure. As shown in FIG. 1, the interactable video player 100 includes a processor 102, a memory 104, a display screen 106, a communication interface 108, a user interface 110, and a control interface 112, and one or more bus 114 to couple the components together. Certain components may be omitted and other components may be included.

The processor 102 may include any appropriate processor or processors. Further, the processor 102 can include multiple cores for multi-thread or parallel processing. The processor 102 may execute sequences of computer program instructions or program modules to receive operation data from the user through a user interface; based on the operation data and the non-video data of the interactive video data, generate target video data; and play the target video data on the display screen. The memory 104 may include memory modules, such as ROM, RAM, flash memory modules, and erasable and rewritable memory, and mass storages, such as CD-ROM, U-disk, and hard disk, etc. The memory 104 may store computer program instructions or program modules for implementing various processes, when executed by the processor 102.

Further, the display screen 106 may include any appropriate type of computer display device or electronic device display (e.g., CRT or LCD based devices, touch screens, LED display). The communication interface 108 may include networking devices for establishing connections through a communication network. The user interface 110 may be configured to receive interaction operations from the user. For example, the user interface 110 may include one or more of a keyboard, a mouse, a joystick, a microphone, and a camera, etc. The control interface 112 is configured to control interne-of-things (IoT) devices, such as a light, an air conditioner, or a smart fan to change a temperature, a relative humidity, an air flow, a brightness, or a color in ambience of the user.

In some embodiments, the interactable video player allows a single user to interact with a single video stream in an interactable video sequence, which includes video data and non-video data such as three-dimensional (3D) scene (or graphical environment), gaming data (or gaming rules), interaction formula, and device control (or hardware control command). The interactable video player generates a target video sequence based on the interaction between the user and the interactable video sequence. When multiple interactable video players are connected through a communication network, the user enjoys not only the interactive experience with the interactable video sequence played by the interactable video player, but also collaboration experience with other users of other connected interactable video players. Thus, the interactable video player transforms the user's video watching experience to a multimodal interactive experience.

In some embodiments, the interactable video sequence may be streamed in real time and the interaction between the user and the interactable video player may occur in real time while the video stream is played on the display screen. In some other embodiments, the interactable video sequence may be a video file stored in the interactable video player in advance. In this case, the interaction between the user and the interactable video player may occur before the video sequence is played on the display screen.

The interactable video sequence enables the user to interact with the interactable video player. The interactable video sequence adopts a data format that not only allows the interaction but also is compatible with non-interactable video standards. As such, the interactable video sequence can be played by the interactable video player that allows the user interaction and by a non-interactable video player that does not allow the user interaction.

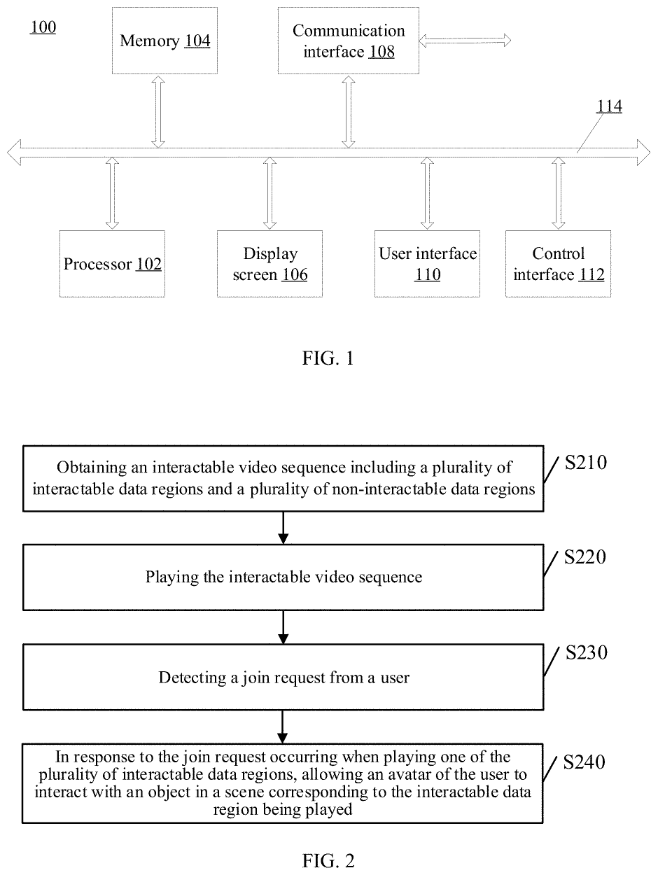

The present disclosure also provides an interactable video playback method. FIG. 2 illustrates a flowchart of an exemplary interactable video playback method according to some embodiments of the present disclosure. As shown in FIG. 2, the method includes the following processes.

At S210, an interactable video sequence including a plurality of interactable data regions and a plurality of non-interactable data regions is obtained.

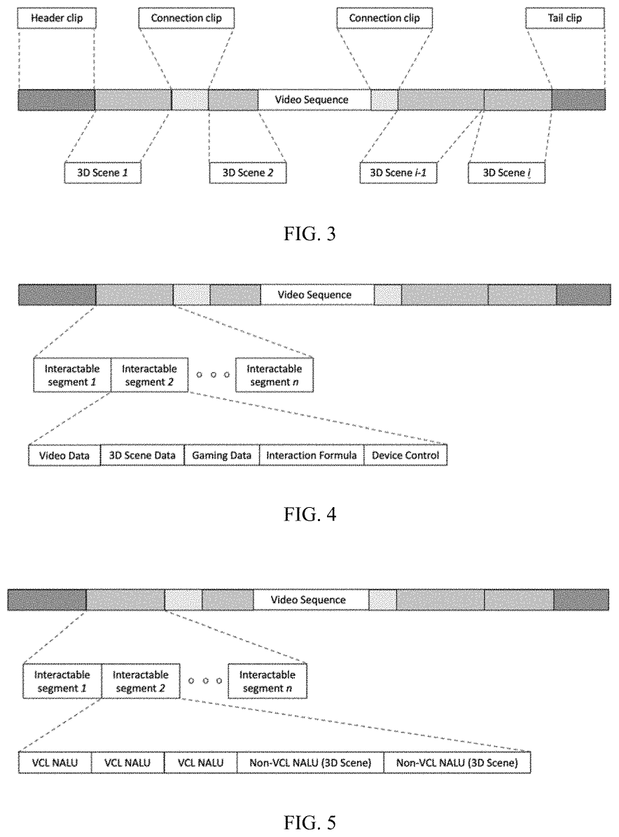

In some embodiments, as shown in FIG. 3, the interactable video sequence includes a header clip (belonging to a non-interactable data region), a plurality of 3D scenes (belonging to interactable data regions) stitched together by a plurality of connection clips (belonging to non-interactable data regions), and a tail clip (belonging to a non-interactable data region). The plurality of 3D scenes is interactable and the plurality of connection clips is not interactable.

In some embodiments, as shown in FIG. 4, each of the plurality of interactable data regions includes a plurality of interactable segments. Each of the plurality of interactable segments includes video data and non-video data. The non-video data includes 3D scene data, gaming data, interaction formula, device control, or a combination thereof

Referring to back to FIG. 2, at S220, the interactable video sequence is played.

To interact with the interactable video player, the user needs to set up profile data at the interactable video player. The profile data include a digital representation of the user (or a digital person), in a 3D virtual world, such as an avatar of the user. When being assisted by the auto-cinematography technology, the digital person can perform as a character in the interactable video sequence. The auto-cinematography technology handles filmmaking entirely in the 3D virtual world with digital persons, digital objects, and digital environment models. In some embodiments, the interactable video sequence includes both the rendered 3D scenes and two dimensional (2D) real-world performances (or 2D video clips). The 2D video clips such as the header clip, the plurality of connection clips, and the tail clip are created by non-interactable video editors and do not support user interactions. The 3D scenes are generated by the auto-cinematography technology and support the user interactions.

Referring back to FIG. 2, at S230, a join request from the user is detected.

In some embodiments, the interactable video player includes the user interface. The user makes the join request to the interactable video player through the user interface.

Referring back to FIG. 2, at S240, in response to the join request occurring when playing one of the plurality of interactable data regions, an avatar of the user is allowed to interact with an object in a scene corresponding to the interactable data region being played.

In some embodiments, the object can be a physical item in the scene or a character in the scene.

In some embodiments, the method further includes, in response to the join request occurring when playing one of the plurality of non-interactable data regions, the join request is ignored and the interactable video sequence continues to be played.

In some embodiments, after the avatar of the user is allowed to interact with the object, the interactable video player detects whether the user makes a leave request. In response to detecting the leave request from the user, the interactable video player disables the avatar of the user from interacting with the object and resumes to playing the interactable video sequence.

In some embodiments, the interactable video data format is compatible with non-interactable video standards such as MPEG-4, ITU-T H.264 and H.265 and can be decoded by a non-interactable standard video player. Further, the interactable video data includes not only the video data, but also the non-video data such as graphical environment, gaming rules, interaction formula, hardware control commands, etc. The non-video data may be used to support the user interactions and will be described in detail below. In addition, the relationship between the video and associated non-video data can be maintained with a data structure design as described below.

In some embodiments, as shown in FIG. 4, an interactable data region of the interactive video sequence includes a plurality of interactable segments, generated by an interactive video creation and encoding process. A size of the interactable data region is determined based on an amount of data to be encoded and a size of maximum transfer unit (MTU). As shown in FIG. 4, each of the plurality of interactable segments includes the video data and the non-video data. The non-video data include the 3D scene data, the gaming data, the interaction formula, the device control, or a combination thereof An order of the non-video data is shown for illustration purpose. The actual order of the non-video data can be determined according to real needs.

The ITU H.264, H.265, and MPEG video standards define a video coding layer (VCL) and a non-VCL layer in a video syntax. The VCL layer includes bits associated with compressed video, and the non-VCL layer includes sequence and picture parameter sets, fill data, supplemental enhancement information (SEI), display parameter, etc. The VCL layer and the non-VCL layer are encapsulated into network abstraction layer units (NALU). The first byte of the NALU specifies a type of the NALU, such as VCL and non-VCL SEI. In the OUT H.264, H.265, and MPEG video standards, the non-VCL NALU often includes non-video data (such as user defined data), such that the non-video data can be decoded at a receiver side without affecting decoding of the video data.

In some embodiments, the interactable data region of the interactable video sequence includes the plurality of interactable segments that follow similar strategy as the ITU H.264, H.265, and MPEG video standards. For example, the video corresponding to each scene can be divided into smaller interactable segments of 20 seconds each. Thus, user interaction data for the 20-second interactable segment can be coded into a non-VCL NALU, and the 3D scene data can be coded at the first interactable segment and need not to be repeated in the subsequent interactable segments. As such, at an interactable video encoder side, a granularity of the interactable segment can be determined flexibly. For example, for handling high frequency interactions, each video frame includes the interactable segment. For handling low frequency interactions, a video scene lasting 2-5 minutes may only include one interactable segment. In addition, coding efficiency of the interactable video sequence shown in FIG. 4 can be optimized at the interactive video encoder side.

At the interactable video player, the interactable video decoder parses the interactable video sequence to separate the video data and the non-video data, and maps the video data with the non-video data at each interactable segment. At the standard video player, a standard video decoder (e.g., an MPEG-4 decoder, an H.264 decoder, an H.265 decoder) parses the interactable video sequence to obtain and decode the video data for displaying and discards the non-video data for the user interactions.

In some embodiments, the plurality of interactable segments is generated from the 3D rendering engine. The user can freely decide when and how much to interact with the story of the interactable video sequence. At any time, the user can enter the immersive 3D environment of each scene in the story by controlling the user's avatar. In this case, the user embraces a rich set of interactable possibilities, including in-depth exploration, conversations with characters, and gamified quests to guide the story. The user also has the option to watch the user's avatar explore the 3D environment automatically for a lean-back experience.

In some embodiments, the interaction with the object allowed by the avatar of the user is determined based on the one or more non-video data included in an interactable segment corresponding to the scene of the interaction.

In some embodiments, based on the interaction formula included in the interactable segment, the interaction of the avatar of the user with the object includes talking to the character, performing a physical action on the object, taking over voice of the character, acting in place of the character, measuring a distance of the object from the avatar, X-ray scanning the object to see through, filtering a type of objects within a distance range, or a combination thereof. When the avatar of the user talks to the character, the character is powered by a story-smart artificial intelligence natural language processing engine

FIG. 5 illustrates another sample interactable segment according to some embodiments of the present disclosure. In some embodiments, As shown in FIG. 5, the interactable video sequence includes a mixed combination of VCL NALU and non-VCL NALU that contains 3D scene for each interactable segment. In this way, for the period of time corresponding to the interactable segment, the interactable video sequence can be decoded from VCL NALU, and the corresponding 3D scene data of non-VCL NALU can be used to reconstruct the 3D scene. With both the video data and the 3D scene data available, the interactable video player can support the user's avatar to enter the scene or return to the 2D video watching mode. For illustration purpose, the non-video data are described in detail below to demonstrate the embodiments of the present disclosure.

In some embodiments, the gaming data (or gaming rules) allows the user to perform at least one of the following operations: playing a game when watching a 2D video; interacting with the 2D video with a pre-defined interaction pattern; playing a game after entering the 3D scene; and/or interacting with the 3D scene with a pre-defined interaction pattern.

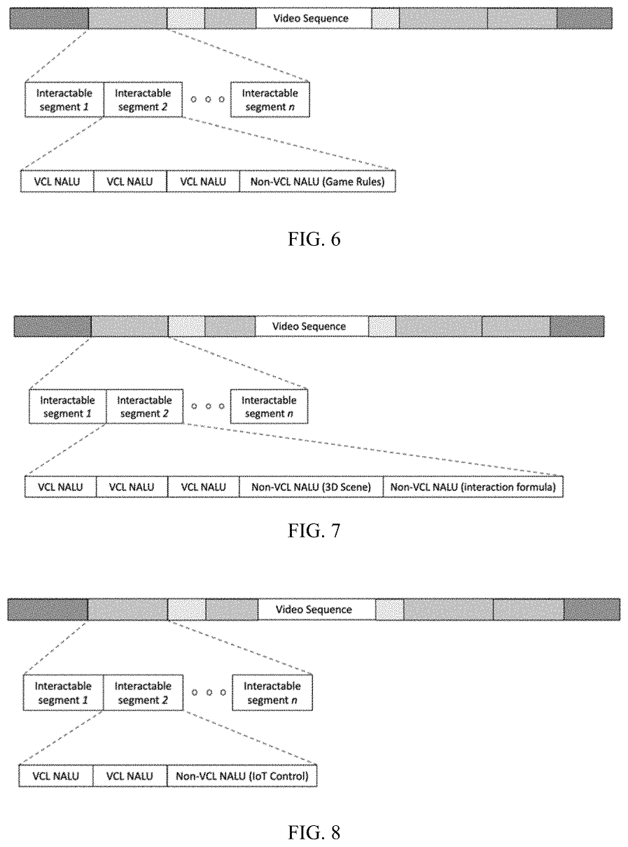

FIG. 6 illustrates another sample interactable segment according to some embodiments of the present disclosure. As shown in FIG. 6, to facilitate the user to play a game when watching a 2D video, the interactable video sequence includes multiple VCL NALUs and a non-VCL NALU where the game rules are specified. In response to the non-video data included in the interactable segment including the game data, the user is allowed to play a game in the scene based on the game data, where the game data defines rules for winning, rewards of winning, losing, and penalty of losing. For example, the game rules define letting the user click on faces in the video and collecting a number of faces within a limited time. The game rules need to be encapsulated in the non-VCL NALU in the interactable video sequence, which will guide the interactable video player to prepare for the gaming environment. In this case, the interactable video player needs to obtain position and time of user clicking, and to verify whether the position of the user clicking corresponds to a face in the video.

In some embodiments, in response to the user requesting to play a game, the interactable video player prepares a gaming environment and collecting gaming inputs from the user or the avatar. The gaming environment includes playing a game by the user when the interactable video sequence is played or playing a game by the avatar.

FIG. 7 illustrates another sample interactable segment according to some embodiments of the present disclosure. As shown in FIG. 7, to facilitate the user to interact with the 3D scene with the pre-defined interaction pattern, the video sequence includes VCL NALUs and non-VCL NALUs where the 3D scene and interaction formula are specified. For example, the interactions that can be specified for the user's avatar in 3D exploration include: measuring a distance of an object from the user's avatar; X-ray scanning an object to see through; and filtering objects within a distance range from the user's avatar.

The interactable video player needs to understand the interaction formula specified in the interactable video sequence to support the user with the interaction capabilities.

A smart home includes IoT devices that can be controlled in real-time. The IoT devices can contribute in the immersive TV watching or gaming experiences. For example, the air conditioning or smart fans can blow cold or warm breeze to the user, smart lights can create ambient lighting effect, smart speakers can create surrounding sound effect, smart clothes can let the user feel touch effect, and VR/AR glasses or 3D screens can bring immersive visual effect.

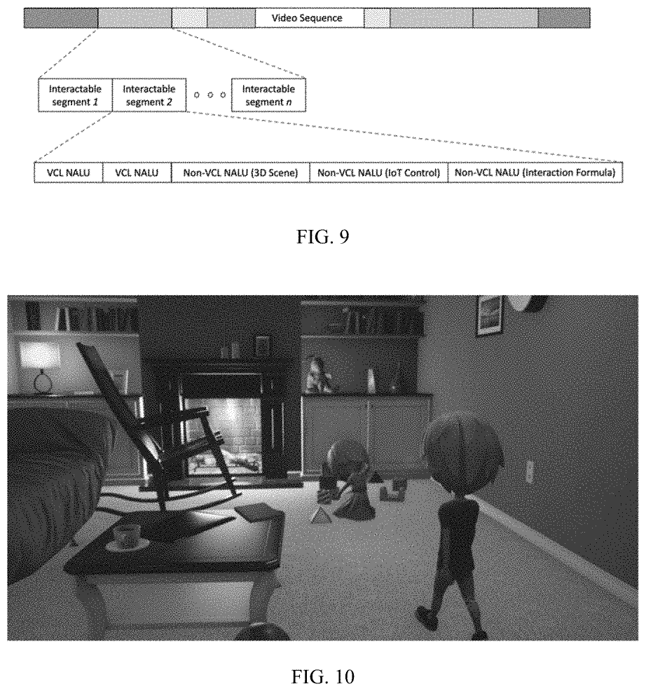

FIG. 8 and FIG. 9 illustrate sample interactable segments according to some embodiments of the present disclosure. As shown in FIG. 8 and FIG. 9, to facilitate controlling the IoT devices to enhance the user's experience, the interactable video sequence includes VCL NALUs and non-VCL NALUs where the IoT device control commands and interaction formula are specified. In response to the non-video data included in the interactable segment including the device control, controlling an internet-of-things (IoT) device to adjust an operation status when the video data included in the interactable segment is played. The IoT device is a light, an air conditioner, or a smart fan to change a temperature, a relative humidity, an air flow, a brightness, a color in ambience of the user, or a combination thereof

The IoT device control commands stored in the non-VCL NALU can effectively control the exact IoT device to turn on or turn off with specific effect at the exact time. The IoT device operations are synchronized with the video content stored in the VCL NALU. For example, when the character in the video walks out of the house and the outside weather is cold, the smart fan with cold breeze can bring the cool feeling to the user. In another example, when the user's avatar gets close to a beach, the ocean scent can be released by a corresponding IoT device. In another example, when the user's avatar is hit by a gun shot, the user wearing a smart sweater can feel the pressure simulating the gun shot.

More examples of the interactable video watching experience are described below.

FIG. 10 illustrates a sample two-dimensional (2D) video frame or a same three-dimensional (3D) scene according to some embodiments of the present disclosure. As shown in FIG. 10, a 2D video frame or a 3D scene is demonstrated. The 3D scene is rendered and played back by the interactable video player.

FIG. 11 illustrates user's avatar walking inside the 3D scene according to some embodiments of the present disclosure. As shown in FIG. 11, the user's avatar enters the 3D scene.

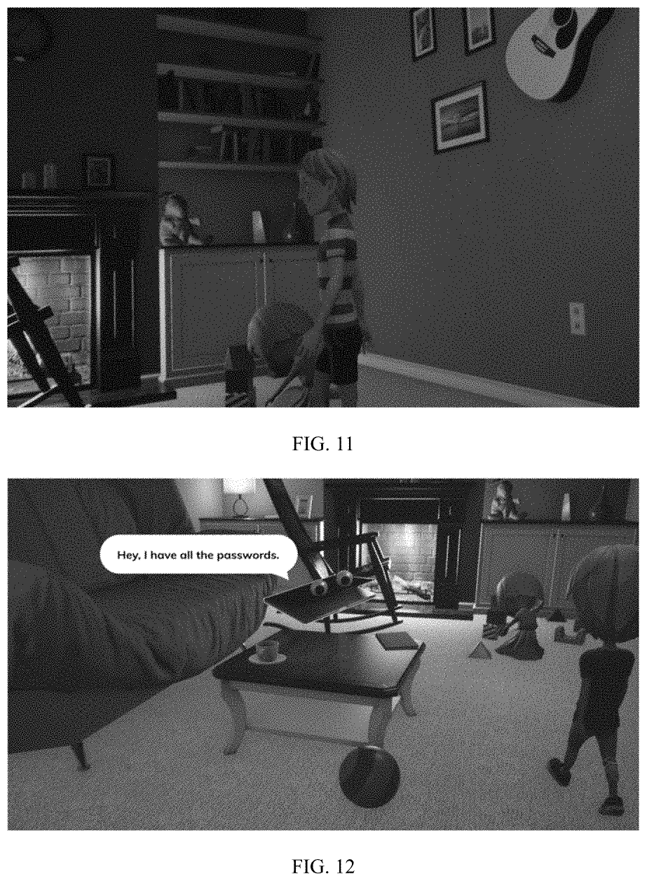

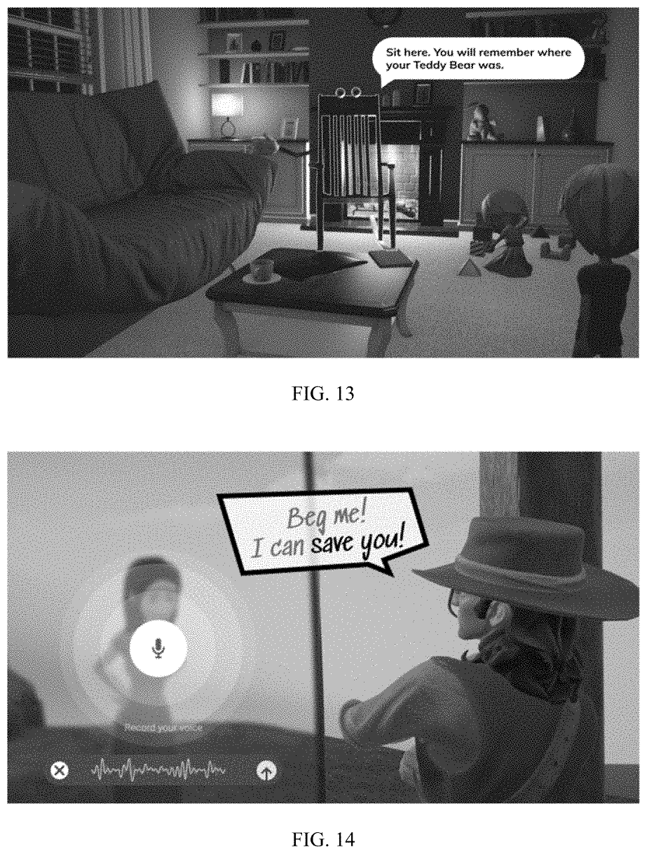

FIG. 12 and FIG. 13 illustrate sample objects being interactable according to some embodiments of the present disclosure. As shown in FIG. 12, the user's avatar is talking to a laptop computer in the 3D scene. As shown in FIG. 13, the user's avatar is talking to a chair in the 3D scene.

FIG. 14 illustrates user taking over the voice of a character according to some embodiments of the present disclosure. As shown in FIG. 14, the user's avatar takes over a role in a video and starts conversation with another character. This is a type of gamification and the game rule or interaction formula needs to be stored in advance in the interactable video sequence, such that the interactable video player is able to support this feature. Depending on the interaction formula specified in the interactable video sequence, the following scenarios are described.

In some embodiments, the user selects a character (e.g., the girl in FIG. 14) to take over. The user (e.g., a female) records her voice (or even using her own avatar to replace the original character to perform). Accordingly, a new video clip is generated with her own performance by the interactable video player. This scenario can be extended for multiple users to take over multiple characters in the video.

In some embodiments, the user selects the character (e.g., the girl in FIG. 14) to take over. The user (e.g., a female) enters the 3D scene through the user's avatar to freely talk to another character. In this case, the character is powered by a story-smart AI and NLP engine to support the conversation with the user's avatar. The conversation can be recorded into a video clip for the user to share to social networks.

In the embodiments of the present disclosure, the interactable video player processes the interactable video sequence and allows various interaction with the interactable video by the user. The interactable video sequence can also be played by the non-interactable video player without the user's interaction. The data needed to control the user interaction is encapsulated in the interactable video sequence. The interactable video playback experience makes the user's video watching experience become a much richer multimodal multimedia gaming experience, with the potential of multi-device collaborative participations.

In the specification, specific examples are used to explain the principles and implementations of the present disclosure. The description of the embodiments is intended to assist comprehension of the methods and core inventive ideas of the present disclosure. At the same time, those of ordinary skill in the art may change or modify the specific implementation and the scope of the application according to the embodiments of the present disclosure. Thus, the content of the specification should not be construed as limiting the present disclosure.

What is claimed is:

1. An interactable video playback method, comprising:
obtaining an interactable video sequence including a plurality of interactable data regions and a plurality of non-interactable data regions, wherein each interactable data region stores video data and non-video data associated with interaction, and each non-interactable data region stores a two-dimensional (2D) video clip;
playing the interactable video sequence;
detecting a join request from a user; and
in response to the join request occurring when playing one of the plurality of interactable data regions, allowing an avatar of the user to interact with an object in a scene corresponding to the interactable data region being played.

2. The interactable video playback method according to claim 1, further comprising:
in response to the join request occurring when playing one of the non-interactable data regions, ignoring the join request and continuing to play the interactable video sequence.

3. The interactable video playback method according to claim 1, after allowing the avatar of the user to interact with the object, further comprising:
detecting a leave request from the user; and
disabling the avatar of the user from interacting with the object and continuing to play the interactable video sequence.

4. The interactable video playback method according to claim 1, wherein:
a format of the interactable video sequence is compatible with non-interactable video coding standards;
each interactable data region includes a plurality of interactable segments;
each interactable segment includes video data and non-video data; and
the non-video data includes three-dimensional (3D) scene data, gaming data, interaction formula, device control, or a combination thereof.

5. The interactable video playback method according to claim 4, wherein:
the interaction with the object allowed by the avatar of the user is determined based on the one or more non-video data included in an interactable segment corresponding to the scene of the interaction.

6. The interactable video playback method according to claim 5, wherein:
based on the interaction formula included in the interactable segment, the interaction of the avatar of the user with the object includes talking to the character, performing a physical action on the object, taking over voice of the character, acting in place of the character, measuring a distance of the object from the avatar, X-ray scanning the object to see through, filtering a type of objects within a distance range, or a combination thereof.

7. The interactable video playback method according to claim 6, wherein:
when the avatar of the user talks to the character, the character is powered by a story-smart artificial intelligence natural language processing engine.

8. The interactable video playback method according to claim 4, further comprising:
in response to the non-video data included in the interactable segment including the device control, controlling an internet-of-things (IoT) device to adjust an operation status when the video data included in the interactable segment is played.

9. The interactable video playback method according to claim 8, wherein:
the IoT device is a light, an air conditioner, or a smart fan to change a temperature, a relative humidity, an air flow, a brightness, a color in ambience of the user, or a combination thereof.

10. The interactable video playback method according to claim 4, further comprising:
in response to the non-video data included in the interactable segment including the game data, allowing the user to play a game in the scene based on the game data, wherein the game data defines rules for winning, rewards of winning, losing, and penalty of losing.

11. The interactable video playback method according to claim 10, further comprising:
preparing a gaming environment; and
collecting gaming inputs from the user or the avatar.

12. The interactable video playback method according to claim 11, wherein:
the gaming environment includes playing a game by the user when the interactable video sequence is played or playing a game by the avatar.

13. An interactable video player, comprising:
a display screen for displaying a video sequence;
a memory storing program instructions; and
a processor coupled with the memory and configured to execute the program instructions to:
obtain an interactable video sequence including a plurality of interactable data regions and a plurality of non-interactable data regions, wherein each interactable data region stores video data and non-video data associated with interaction, and each non-interactable data region stores a two-dimensional (2D) video clip;
play the interactable video sequence;
detect a join request from a user; and
in response to the join request occurring when playing one of the plurality of interactable data regions, allow an avatar of the user to interact with an object in a scene corresponding to the interactable data region being played.

14. The interactable video player according to claim 13, further comprising:
a user interface configured to receive interaction operations from the user, wherein the processor is further configured to execute the program instructions to receive the interaction operations from the user interface while the interactable video sequence is played on the display screen.

15. The interactive video player according to claim 13, wherein:
a user profile is stored in the memory in advance; and
the user profile at least includes user avatar data.

16. The interactable video player according to claim 13, wherein the processor is further configured to:
in response to the join request occurring when playing one of the non-interactable data regions, ignore the join request and continue to play the interactable video sequence.

17. The interactable video player according to claim 13, wherein after allowing the avatar of the user to interact with the object, the processor is further configured to:
detect a leave request from the user; and
disable the avatar of the user from interacting with the object and continuing to play the interactable video sequence.

18. The interactable video player according to claim 13, wherein:
a format of the interactable video sequence is compatible with non-interactable video coding standards;
each interactable data region includes a plurality of interactable segments;
each interactable segment includes video data and non-video data; and
the non-video data includes three-dimensional scene data, gaming data, interaction formula, device control, or a combination thereof

19. The interactable video player according to claim 18, wherein:
the interaction with the object allowed by the avatar of the user is determined based on the one or more non-video data included in an interactable segment corresponding to the scene of the interaction.

20. The interactable video playback method according to claim 19, wherein:
based on the interaction formula included in the interactable segment, the interaction of the avatar of the user with the object includes talking to the character, performing a physical action on the object, taking over voice of the character, acting in place of the character, measuring a distance of the object from the avatar, X-ray scanning the object to see through, filtering a type of objects within a distance range, or a combination thereof.
